(19) United States
(12) Patent Application Publication
(10) Pub. No.: US 2010/0041849 A1
(43) Pub. Date: Feb. 18, 2010

(54) HIGHLY ESTERIFIED POLYOL POLYESTERS WITH ONE PAIR OF CONJUGATED DOUBLE BONDS

(76) Inventors: Roger Stephen Berger, Fairfield, OH (US); Deborah Jean Back, Cleves, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/537,271

(22) Filed: Aug. 7, 2009

Related U.S. Application Data
(60) Provisional application No. 61/089,658, filed on Aug. 18, 2008.

(51) Int. Cl. C08F 251/00

(52) U.S. Cl. 527/314

(57) ABSTRACT

A composition comprising a highly esterified polyol polyester wherein the polyester comprises a polyol residue and a plurality of fatty acids esters, and wherein from about 5% to about 80% of the fatty acid esters contains exactly one pair of conjugated double bonds.

### CROSS REFERENCE TO RELATED APPLICATIONS

This application claims priority under 35 U.S.C. §119(e) to U.S. Provisional Application Ser. No. 61/089,658 filed Aug. 18, 2008.

### FIELD OF THE INVENTION

The disclosure herein relates to a new polyol polyester composition for use as a multifunctional, non-volatile component in alkyd-based paints and/or coating compositions. More particularly the disclosure relates to a highly esterified polyol polyester having conjugated ester side chains.

Volatile organic compounds (VOCs) are organic chemical compounds that have vapor pressures under normal conditions that are sufficiently high to allow them to vaporize and easily enter the atmosphere. Typical VOCs are light hydrocarbons such as paint thinner or gasoline. Many VOCs are applied in industrial uses including the manufacture and application of polymeric coatings, resins, or finished coatings.

Considerable effort has been expended in recent years to develop coating compositions that require low VOC content due to environmental hazards associated with VOCs. The level of VOC content for architectural and industrial maintenance coatings, for example, is limited by regulation. The regulatory restrictions have encouraged research and development to explore new technologies directed at reducing typical VOC solvent emissions from the application of coatings in a variety of industries.

European Patent EP 1470200B1 has previously disclosed the concept of replacing volatile solvents in paint and resin applications with reactive diluents. Reactive diluents reduce the viscosity of the paint during application but are subsequently incorporated into the polymeric network coat upon drying. EP 1470200B 1 teaches the use of fatty acid modified carbohydrates as reactive diluents. However, while EP 1470200B1 teaches the value of fatty acid modified carbohydrates as achieving desired lower viscosity, low VOC resins and paints, the resulting resins and paints are uncontrolled in drying performance. Paints and resins incorporating many of the fatty acid modified carbohydrates of EP 1470200, including the exemplified compositions exhibit unacceptable drying profiles. That is they either take much too long to dry or dry so fast that the coatings obtain insufficient adhesion to the coated surface.

It has now been surprisingly discovered that a modified form of a highly esterified polyol polyester, originally developed as a replacement for shortening in foods, provides excellent and unexpected benefits as a major component or additive in traditional solvent borne alkyd resins and subsequent paint compositions. Specifically, modified forms of the polyol polyesters described in U.S. Pat. No. 5,021,256 have been found to act as a non-volatile solvent that provides optimal viscosity control of alkyd resins compositions and paint formulations enabling full or partial replacement of traditionally used volatile solvents. The disclosed polyol polyesters may also be used as a reactive film-former that provides for a low viscosity liquid form upon making and in storage, but that dries in a controlled manner. Without being bound by theory, Applicants believe that the polyol polyesters work synergistically with alkyd resin and other constituents of a coating when undergoing auto-oxidative polymeric cross-linking. This allows for enhanced surface adhesion and film properties.

### SUMMARY OF THE INVENTION

Described herein is a composition which comprises a highly esterified polyol polyester. The polyol polyester comprises a polyol residue and a plurality of fatty acid ester groups where from about 5% to about 80% of the fatty acid esters contain exactly one pair of conjugated double bonds. Also described herein are alkyd resins and other coating compositions comprising the new polyol polyester, with solvent-like properties, taking the place of VOC solvents, in storage in its liquid state, and forming a coating with the other active constituents of the material with which it is used upon drying. Further, the polyol polyesters described herein may be used to control the drying times upon application to a surface.

In one embodiment, the composition may comprise two or more different highly esterified polyol polyesters wherein from about 5% to about 80% of the total fatty acid esters in the compositions contain exactly one pair of conjugated double bonds. In one or more embodiments of the composition of the invention, the polyol residue may be selected from the group consisting of sugars and sugar alcohols. Each polyol may have an average esterification of from about 50% to about 100%.

Also described are compositions comprising a highly esterified polyol polyester comprising a polyol residue and a plurality of fatty acid ester groups wherein the polyol has been esterified by the reaction with one or more fatty acid methyl esters derived from a material selected from the group consisting of soybean oil, safflower oil, sunflower oil, castor oil, dehydrated castor oil, lesquerella oil, dehydrated lesquerella oil, linseed oil, flaxseed oil, cottonseed oil, tall oil, canola oil, corn oil, olive oil, palm olien, tung oil, and combinations thereof, in relative amounts sufficient to have from about 5% to about 80% of the fatty acid ester groups containing exactly one pair of conjugated double bonds.

### DETAILED DESCRIPTION OF THE INVENTION

Highly Esterified Polyol Polyester

The present invention relates to a composition comprising a highly esterified polyol polyester comprising a polyol residue and a plurality of fatty acid ester groups wherein from about 5% to about 80% of the fatty acid ester groups contain exactly one pair of conjugated double bonds.

The term “polyol” as used herein means a polyhydric alcohol containing four or more hydroxyl groups. Examples include, without limitation, sugars and sugar alcohols, sorbitol, glycol, and others. Triglycerides having three hydroxyl groups are excluded from the term “polyol” as used herein. The term “polyol residue” as used herein means the core of the polyol molecule after one or more of the polyol hydroxyl groups have been reacted into an ester group.

Example polyols for preparing the polyol polyesters for use in the present invention are those having at least four hydroxy groups, or esterification sites to which the fatty acids are covalently bound. In one or more embodiments of the composition of the invention, the polyol may be selected from the group consisting of sugars and sugar alcohols. Selected embodiments of the present polyol polyester comprise a polyol residue selected from the group consisting of adonitol, arabitol, sorbitol, mannitol, galactitol, isomalt, lactitol, xylitol, maltitol, 1-methyl-glucopyranoside, 1-methyl-galactopyranoside, 1-methyl-mannopyranoside, dextrin, erythritol, pentaerythritol, diglycerol, polyglycerol, sucrose, amylose, nystose, kestose, trehalose, raffinose, gentianose and mixtures thereof. Certain embodiments utilize polyols selected from the group consisting of xylitol, sorbitol, glucose and sucrose. Sucrose may be used in some embodiments.

The highly esterified polyol polyester comprises a plurality of fatty acid ester groups. As used herein, “highly esterified” means a structure condition wherein at least 50% of the available hydroxyl groups of a polyol have been esterified. Specific embodiments of highly esterified polyol polyesters may have from about 70% to 100%, or even from about 85% to about 100% of the available hydroxyl groups esterified. The plurality of fatty acid ester groups of the polyol polyester may comprise one or more fatty acids selected from the group consisting of anteisoarachadic, behenic, bosseopentaenoic acid, calendic, capric, caprylic, catalpic, eicosadienoic, eleostearic, erydiogenic, isomargaric, isomyristic, isostearic, jacaric, lauric, lesquerolic, licanic, linoleic, linolenicmaleic, myristic, oleic, palmitic, parinaric, punicic, ricinoleic, rumenic, ricinenic, and stearic acids. In some embodiments of the polyol polyester, the fatty acids are selected from the group consisting of stearic acid, oleic acid, linoleic acid, linolenic acid, eleostearic acid, ricinoleic, conjugated linoleic acid, ricinenic, rumenic acid and mixtures thereof. The fatty acids can be derived from naturally occurring or synthetic fatty acids; they can be saturated or unsaturated, including positional and geometrical isomers (e.g., cis and trans isomers). The fatty acids esterified to the polyol molecule may be mixed fatty acids to produce the desired physical properties

The polyol polyester of the present invention comprises fatty acid ester groups wherein from about 5% to about 80%, or from about 10% to about 60%, or from about 15% to about 40% of the fatty acid esters contain exactly one pair of conjugated double bonds. As used herein a “pair of conjugated double bonds” means two double bonds in an unsaturated carbon chain that are non-methylene interrupted. As such the chemical structure of the conjugated double bond is —C═C—C═C— where the two C═C groups are separated by only one single bond. “Conjugated fatty acids” as used herein means a fatty acid containing conjugated double bonds, such as polyunsaturated fatty acids in which at least one pair of double bonds are non-methylene interrupted. Conjugated fatty acids having exactly one pair of conjugated double bonds include conjugated linoleic acid, ricinenic acid (for example, 9,11-octadecadienoic acid or 10,12-octadecadienoic acid), rumelenic acid (for example, 9,11,15-octadecatrienoic acid), 11,13-eicosadienoic acid and rumenic acid (for example, cis-9, trans-11-octadecadienoic acid). Example embodiments of the polyol polyester may comprise from about 8% to about 24% of a conjugated linoleic acid.

Specific, but non-limiting, examples of polyol fatty acid polyesters suitable for use herein are polyol polyester compositions made by esterifying sucrose with a single fatty acid or source of fatty acids, or a blend of either in relative amounts sufficient to provide from about 5% to about 80% of the ester fatty acids which contain only one pair of conjugated double bonds. In various embodiments, a preferred highly-esterified sucrose has an average distribution of fatty acid esters on the sucrose backbone of 6 to 8, and preferably from 7 to 7.5, wherein the fatty acid moieties each contain preferably from 12 to 22 carbon atoms and most preferably contain primarily 18 carbon atoms. Fatty acids of different carbon length can be used.

One embodiment of the composition of the present invention comprises a polyol polyester composition that includes one or more sucrose polyesters, each having an average esterification of about 7-7.5 with dehydrated castor oil which comprises 22.5% conjugated rumenic acid, preferably cis, cis-9,11 octadecadienoic acid or another C18:2 (n-7) fatty acid.

The polyol polyesters described herein can be prepared by a variety of general synthetic methods known to those skilled in the art, including but not limited to, transesterification of the polyol with the desired fatty acid esters and any of a variety of suitable catalysts, acylation of the polyol with a fatty acid chloride, acylation of the polyol with a fatty acid anhydride, and acylation of the polyol with a fatty acid. The preparation of polyol fatty acid polyesters is described in U.S. Pat. No. 6,121,440. The preparation of polyol fatty acid esters is described in U.S. Pat. Nos. 4,518,772; 4,517,360; and 3,963,699.

In general, the polyol polyester is made by reaction of a polyol with a fatty acid methyl ester derived from suitable source oil in the presence of fatty acid soap, for example potassium stearate, and an alkaline catalyst, preferably potassium carbonate. The reaction is driven to completion at a temperature of from about 115° C. to about 135° C., preferably 135° C., by removal of methanol from the reaction. Methanol removal is assisted by the application of nitrogen sparge and/or vacuum distillation at from about 1 to about 760 mm Hg pressure. The crude polyol polyester is further processed to remove the excess soap via hydration/centrifugation. Decolorization of the crude oil mixture is achieved via bleaching earth addition followed by mixing and filtration. Removal of excess fatty acid methyl ester is then accomplished by vacuum distillation.

Alternatively, the polyol polyester can be made by the reaction of polyol and fatty acid chloride which is derived from suitable source oil, in a solvent mixture consisting of pyridine and N,N-dimethylformamide at a temperature of from about 40° C. to about 80° C. An excess of pyridine is used in order to complex HCl which is formed during the esterification. The desired polyol polyester is then isolated by extraction into solvent followed by water washing. The organic layer is separated and dried over MgSO₄, then filtered to remove the solids. The solvent is removed via vacuum distillation using a rotary evaporator. The polyol polyester is then extracted several times with methanol to remove any residual fatty acid, and then dried of solvent using a rotary evaporator.

Another method of preparation uses a solvent, preferably N,N-dimethylacetamide, to react the polyol and fatty acid methyl ester derived from suitable source oil. This method uses alkaline catalysis, preferably potassium carbonate, and the reaction is carried out at a temperature of about 120° C. under reduced pressure, preferably from about 15 to about 20 mm Hg. Upon completion of the reaction the excess solvent is distilled off at reduced pressure, for example at a pressure of less than about 1 mm Hg. The polyol polyester is then extracted into solvent, preferably hexanes or petroleum ether, and water washed. The organic phase is isolated and then washed with methanol to remove any residual fatty acid methyl ester. The solvent is then removed via vacuum distillation.

Embodiments of the polyol polyester can be prepared by esterification reaction of a polyol with one or more fatty acid methyl esters derived from a material selected from the group consisting of soybean oil, safflower oil, sunflower oil, castor oil, dehydrated castor oil, lesquerella oil, dehydrated lesquerella oil, linseed oil, flaxseed oil, cottonseed oil, tall oil, canola oil, corn oil, olive oil, palm olien, tung oil, and combinations thereof in relative amounts sufficient to have from about 5% to about 80% of the fatty acid esters in the polyol polyester containing exactly one pair of conjugated double bonds. One embodiment of the polyester may have an average esterification of from about 70% to 100% formed by a process of esterifying sucrose with a blend of fatty acid methyl esters derived from oils comprising dehydrated castor oil, soy bean oil and mixtures thereof. Another embodiment may be a sucrose polyester having an average esterification of from about 70% to 100% formed by a process of esterifying sucrose with a blend of oils comprising of from about 20% to less than 100% dehydrated castor oil and from greater than 0.1% to about 80% soybean oil. Yet another embodiment may include a sucrose polyester esterified with a blend of fatty acid methyl esters derived from oils comprising from about 40% to about 60% dehydrated castor oil and from about 40% to about 60% soybean oil. In one embodiment, the oils may comprise from about 50% dehydrated castor oil, and about 50% soybean oil. For purposes of clarity, the oils may be blended prior to forming a fatty acid methyl ester blend, or alternatively, the fatty acid methyl esters may be formed from separate oils, and then combined to form a fatty acid methyl ester blend.

In an embodiment of the composition of the present invention, the polyol polyester may be a sucrose polyester having an average esterification of from about 6 to about 7.5, or about 7 to about 7.5 esterified with a blend of dehydrated castor oil and soybean oil such that the blend of oils having the proper conjugation within the fatty acid chains. The blend may comprise as little as about 20% dehydrated castor oil which results in about 8% of a conjugated linoleic acid (octadecadienoic acid (C18:2)), or other conjugated fatty acid, content going into the esterification step. Alternatively, sucrose polyesters having an average esterification of about 6 may be used.

Paint and Resin Products

The polyol polyester compositions of the present invention show improved drying benefits as a low VOC, low viscosity component when incorporated into paint and resin coatings. The present invention also relates to an alkyd resin composition comprising the highly esterified polyol polyester described herein and a polyol-polyacid alkyd.

Alkyd resins are long established binders for film coating compositions. Alkyds are in general the reaction product of the esterification of polyhydric alcohols with polybasic acids or their anhydrides and fatty acids or glycerol ethers thereof. The properties of the alkyds are primarily determined by the nature and the ratios of the alcohols and acids used and by the degree of condensation. For example alkyd resins are generally grouped by their “oil length”. An alkyd having from about 30% to about 40% fatty acid or oil content is know as a “short oil”. An alkyd having from about 40 to about 55% fatty acid content is known as a “medium oil”. An alkyd having greater than about 55% fatty acid content is known as a “long oil.”

The alkyd resin of the present invention may comprise from about 10% to about 40%, or from about 15% to about 30% by weight of the alkyd resin, of a polyhydric alcohols, or polyol. The polyols of the alkyd resin include without limitation, glycerol, pentaerythritol, dipentaerythritol, trimethylolethane, trimethylolpropane, ethylene glycol, propylene glycol, neopentylene glycol and dipropylene glycol and combinations thereof.

The polybasic acids, or “polyacids”, or their anhydrides may be comprised in the alkyd resin as levels ranging from 0% to about 40%, or from about 10% to about 30%, by weight of the alkyd resin. The polyacids and anhydrides may include, without limitation, isophthalic acid, terephthalic acid, chlorendic anhydride, tetrahydrophthalic anhydride, hexa hydrophthalic anhydride, phthalic anhydride, maleic anhydride, fumaric acid, azelaic acid, succinic acid, adipic acid, sebacic acid or combinations thereof.

The alkyd resins of the present invention also include from about 25% to about 80%, or from about 35% to about 70%, or from about 40% to about 60% of fatty acids, fatty acid derivatives of oils or a combination thereof. The fatty acids useful in the alkyds may include without limitation, anteisoarachadic, behenic, bosseopentaenoic, capric, caprylic, catalpic, eleostearic, erydiogenic, isomargaric, isomyristic, jacaric, lauric, licanic, linoleic, linolenic, myristic, oleic, palmitic, parinaric, punicic, ricinoleic, rumenic, rumelenic, stearic acids, synthetic fatty acids or mixtures thereof. Fatty acid derivatives of oils useful in the present alkyds include, without limitation, derivatives of linseed oil, soybean oil, dehydrated castor oil, raw castor oil, peanut oil, tall oil, tung oil, fish oil, sunflower oil, safflower oil, cottonseed oil, rapeseed oil, olive oil, coconut oils, or combinations thereof.

The polyol-polyacid alkyd of the present invention may also be further chemically modified through reaction with acrylic monomers, isocyante, rosin or phenolic. The alkyd may be modified by reaction with from about 1% to about 60%, by weight of the resin, with the acrylic monomer where the acrylic monomer may be selected from the group of butyl acrylate, methyl methacrylate, ethyl acrylate, 2-ethylhexylacrylate, methacrylamide, diacetone acrylamide, styrene, vinyl toluene and combinations thereof. The polyol-polyacid alkyd may be modified by reaction with from about 1% to about 40%, by weight of the resin with an isocynate, wherein the isocyanate may be selected from the group of toluene diisocyanate, isophorone diisocyanate, hexamethylene diisocyanate, methylene diphenyl diisocyanate, hydrogenated methylene diphenyl diisocyanate, or combinations thereof. The polyol-polyacid alkyd may also be chemically modified by reaction with rosin. The rosin may be selected from the group consisting of tall oil rosin, gum rosin, brazil gum rosin, maleic modified rosin, and combinations thereof. In this aspect, the rosin may be used at about 1% to about 20% by weight of the polyol-polyacid alkyd. In one aspect, the polyol-polyacid alkyd may be modified by phenolic. The phenolic may be selected from the group consisting of heat reactive phenolic, non-heat reactive phenolic, and combinations thereof. In this aspect, the phenolic may be used at about 1% to about 20% by weight of the polyol-polyacid alkyd.

The polyol-polyacid alkyd of the present alkyd resin may also be chemically modified through reaction with hydroxy-functional or methoxy functional silicone resin accounting for up to about 60% by weight of the alkyd resin composition.

The components of the alkyd are polymerized in the desired ratios for achieve a weight average molecular weight of from about 30,000 to about 80,000 Daltons.

Conventional alkyds are diluted with solvent to a level of about 45% to about 60% solids as supplied to customers. However, it is these VOC solvents that are the subject of regulatory attention. In one aspect, the need for these VOC solvents may be minimized by the use of the highly esterified polyol polyester of the present invention.

The alkyd resin containing the polyol polyester of the present invention may be used in basic paint compositions. In paint making, the alkyd resin may be combined with pigment, driers, crosslinkers, and other additives to produce a paint product. The alkyd resin composition of the present invention provides a preferred low VOC, low viscosity base for making paint with controlled drying character.

The alkyd resin composition of the present invention may be used in coating compositions. The coating compositions may comprise the alkyd resin of the present invention, one or more driers, optionally one of more pigments, one or more solvents or Theological modifiers. The coating compositions may comprise from about 10% to about 80%, by weight of the coating composition, of the alkyd resin. The coating compositions may comprise from about 0.001% to about 0.6%, by weight of the coating composition, of a drier known in the art. These driers include, without limitation, cobalt, zirconium, manganese and calcium. The coating compositions may optionally contain up to about 80%, by weight of the coating composition, of one or more pigments. The coating compositions may optionally contain up to about 80%, by weight of the liquid coating, of a solvent. The coating composition may also optionally contain up to 20% by weight of the coating composition of a rheological modifier.

Analytical Methods

Ester Distribution of Sucrose Polyester via HPLC

The relative distribution of the individual octa-, hepta-, hexa-, penta-, as well as collectively the tetra through mono-esters, of the sucrose polyester can be determined using normal-phase high performance liquid chromatography (HPLC). A silica gel-packed column is used in this method to separate the polyester sample into the respective ester groupings noted above. Hexane and methyl-t-butyl ether are used as the mobile phase solvents. The ester groupings are quantified using a mass detector (i.e. an evaporative light-scattering detector). The detector response is measured and then normalized to 100%. The individual ester groups are expressed as a relative percentage. Additional details related to the method are explained in U. S. Pat. No. 7,276,485 (Cerreta et al.).

FTIR to Measure Reaction Completion (Acid Chloride Route)

The reaction completion of sucrose polyester made using the acid chloride route was determined using a Perkin Elmer, Spectrum One B, Fourier Transform Infra Red Spectrophotometer. A sample was taken, extracted into hexane, water washed, and then the hexane layer was separated and dried over MgSO₄. The dried hexane extract was then evaporated under a stream of nitrogen and analyzed by FTIR (placed between NaCl salt flats, no dilution). The reaction was considered to be complete when the hydroxyl peak (˜3480 cm-1) disappeared and the ester carbonyl (˜1730-50) was maximized.

### EXAMPLES

Highly Esterified Polyol Polyesters

### Example 1

Sucrose Polyester made from Dehydrated Castor Oil Fatty Acid Methyl Ester

Preparation of Dehydrated Castor Oil Fatty Acid Methyl Ester

33258 grams dehydrated castor oil (DCO) are transferred into a 12 L reaction flask assembled for reflux and equipped with the following; cold water condenser, overhead mechanical stirrer, temperature regulator, thermocouple, heating mantle, nitrogen inlet adapter and other misc. glassware adapters). 8838 grams anhydrous methanol and 374 grams of sodium methoxide (25% in Methanol) are then added and the flask was placed under a slight nitrogen blanket to exclude atmospheric oxygen. The contents of the flask are heated to reflux and the reaction was continued to completion as monitored by HPLC (High Performance Liquid Chromatography). Upon reaction completion, the contents of the flask are allowed to cool without stirring until a distinct glycerol layer has separated to the bottom of the flask. The glycerol layer is removed and the oil layer is then water washed several times until the water layer is neutral to pH paper. The water layer is removed and the oil layer is then dried at 110° C. with a constant nitrogen sparge. The DCO fatty acid methyl esters (FAME) are then additionally purified by vacuum distillation yielding a clear, slightly yellow tinged liquid.

Preparation of DCO Sucrose Polyester

2725 grams of fatty acid methyl ester made from Dehydrated Castor Oil are transferred into a 12 L reaction flask along with 106.7 grams potassium stearate, 629.3 grams sucrose and 4.5 grams potassium carbonate. The reaction flask is assembled for distillation, and equipped with the following; cold water condenser, overhead mechanical stirrer, temperature regulator, thermocouple, nitrogen sparge tube, heating mantle, receiving flask, dry ice condenser and misc. glassware adapters. The contents of the flask are mixed with vigorous stirring while heating to 135° C. A nitrogen sparge tube is introduced beneath the liquid surface to assist with methanol removal and to drive the reaction to completion. After the mixture has reacted a few hours, the sucrose will be dissolved and the solution will become a clear, pale brown liquid. 2725 grams additional dehydrated castor oil fatty acid methyl ester are then added along with an additional 4.5 grams potassium carbonate and the reaction was continued at 135° C. until analysis by High Performance Liquid Chromatography (HPLC) indicted greater than about 50% conversion to sucrose octa ester, or more preferably greater than about 60% sucrose octa ester. The contents of the flask are then cooled to 75° C. and approximately 10% water (by weight of batch) was added with gentle mixing. The agitation is then stopped and the hydrated soap is allowed to settle and is removed. The oil layer is then water washed, the water layer removed and the oil layer dried under vacuum (70-90° C., ˜30 mm Hg pressure). The dried oil layer is then mixed with approximately 1% TriSyl bleaching aid for 15 min. at about 90° C. The bleaching aid is then removed by pressure filtration. The crude sucrose polyester is then passed through a wiped film evaporator to remove the excess dehydrated castor oil fatty acid methyl esters. The finished DCO sucrose polyester is then placed into clean glass jars, blanketed with nitrogen, sealed and stored at 40° F.

### Example 2-4

Sucrose Polyester made from Blended DCO and Soy Fatty Acid Methyl Ester

Both dehydrated castor oil and soybean oil fatty acid methyl ester are made separately, according to the procedure outlined in Example 1. The purified fatty acid methyl esters are then blended to make the following methyl ester mixture; 40% DCO FAME/60% Soy FAME (by weight).

Sucrose Polyester made from Blended Methyl Esters 40% DCO FAME/60% soy FAME 4087.5 grams of fatty acid methyl ester made from blended methyl esters (40% DCO/60% Soy) are transferred into a 12 L reaction flask along with 160 grams potassium stearate, 944 grams sucrose and 6.8 grams potassium carbonate. The reaction flask is assembled for distillation, and equipped with the following; cold water condenser, overhead mechanical stirrer, temperature regulator, thermocouple, nitrogen sparge tube, heating mantle, receiving flask, dry ice condenser and misc. glassware adapters. The contents of the flask are mixed with vigorous stirring while heating to 135° C. A nitrogen sparge tube is introduced beneath the liquid surface to assist with methanol removal and to drive the reaction to completion. After the mixture has reacted a few hours, the sucrose has dissolved and the solution becomes a clear, pale brown liquid. 4087.5 grams additional blended fatty acid methyl ester are then added along with an additional 6.8 grams potassium carbonate and the reaction is continued at 135° C. until analysis by High Performance Liquid Chromatography (HPLC) indicates greater than about 50% conversion to sucrose octa ester, or more preferably greater than about 60% sucrose octa ester. The contents of the flask are then cooled to about 75° C. and about 10% water (by weight of batch) is added with gentle mixing. The agitation is then stopped and the hydrated soap is allowed to settle and is removed. The oil layer is then water washed, the water layer removed and the oil layer dried under vacuum at a temperature of about 70° C. to about 90° C. at approximately 30 mm Hg pressure. The dried oil layer is then mixed with approximately 1% TriSyl bleaching aid for about 15 minutes at approximately 90° C. The bleaching aid is then removed by pressure filtration. The crude sucrose polyester is then passed through a wiped film evaporator to remove the excess DCO fatty acid methyl esters. The finished DCO sucrose polyester is then placed into clean glass jars, blanketed with nitrogen, sealed and stored at 40° F.

### Example 3

Example 2 is repeated except that the fatty acid methyl esters are blended to the following mixture; about 50% DCO FAME/about 50% Soy FAME. The sucrose polyester is then made using the blended methyl esters as described in Example 2.

### Example 4

Example 2 is repeated except that the fatty acid methyl esters are blended to the following mixture; about 60% DCO FAME/about 40% Soy FAME. The sucrose polyester is then made using the blended methyl esters as described in Example 2.

### Example 5

Isomerized Sucrose Polyester made from Soybean FAME

A sucrose polyester is made from Soybean FAME according to the procedure of Example 1, wherein the DCO is replaced with soybean oil. 1000 grams of the Soybean sucrose polyester is then transferred into a 2000 ml reaction flask assembled for reflux and equipped with a mechanical stirrer (shaft and paddle), heating mantle, temperature controller, thermocouple, cold water condenser, nitrogen inlet/outlet tubes and various glassware adaptors as needed. A slow flow of nitrogen is introduced below the liquid surface and the stirrer is turned on for moderate agitation. The contents of the flask are then heated to 90° C. A solution of Ruthenium Trichloride-hydrate is prepared by weighing out 0.04 grams RuCl₃-hydrate and dissolving it into 10 milliliters anhydrous ethanol. This solution is then added to the Soybean sucrose polyester slowly with vigorous stirring. Upon complete addition of the isomerization catalyst, the contents of the reaction flask are heated to 180° C. and the reaction is continued at 180° C. for 60-120 minutes. The reaction is monitored for conjugation using FTIR by following peaks at 947 and 985 cm⁻¹. The isomerized Soybean sucrose polyester is then cooled, placed into a clean and labeled jar, and purged with nitrogen before sealing the jar. The product is stored in a cool, dark place.

### Example 6

Sucrose Polyester made from blended Tung Oil FAME and Soy FAME.

Tung oil fatty acid methyl ester is made according to the procedure outlined in Example 1. The Tung Oil FAME is then blended with Soy FAME in the following mixture; 15% Tung Oil FAME/85% Soy FAME.

Preparation of sucrose polyester from the blended Tung Oil FAME and Soy FAME is made following the procedure outlined in Example 1.

### Example 7

Sucrose Polyester made from blended Linseed Oil FAME and Soy FAME.

Linseed oil fatty acid methyl ester is made according to the procedure outlined in example 1. The linseed oil FAME is then blended with Soy FAME in the following mixture; 75% linseed oil FAME/25% Soy FAME.

Preparation of sucrose polyester from the blended Linseed Oil FAME and Soy FAME are made following the procedure outlined in Example 1.

### Example 8

Sucrose Polyester made from Dehydrated Castor Oil Fatty Acid Methyl Esters using a Solvent Process

2000 grams dehydrated castor oil FAME are added to a 12 L reaction flask along with about 5600 grams N,N-dimethylacetamide, about 190 grams sucrose, and about 38 grams potassium carbonate. The reaction flask is assembled for distillation with the following; cold water condenser, overhead mechanical stirrer, temperature regulator, thermocouple, heating mantle, nitrogen inlet adapter, receiving flask, dry ice condenser, vacuum pump, manometer, and misc. glassware adapters. The flask is evacuated to approximately 20 mm Hg pressure, stirred vigorously and heated to approximately 120° C. The reaction is continued until greater than about 60% sucrose octa ester as analyzed by HPLC. The crude reaction mix is then evaporated under full vacuum to remove any remaining solvent. The crude DCO sucrose polyester is then mixed with 1% by weight TriSyl bleaching aid at about 90° C. The bleaching aid is removed by pressure filtration and the excess methyl esters are distilled by passing the product through a wiped film evaporator. The finished DCO sucrose polyester is then placed into clean jars, blanketed with nitrogen, sealed and placed in storage at 40° F.

### Example 9

Sucrose Polyester made from Dehydrated Castor Oil Fatty Acid Chloride

Dehydrated castor oil Fatty Acid Methyl Ester is converted to DCO fatty acid. The DCO fatty acid is then used to make sucrose polyester via the acid chloride route. 2000 grams DCO fatty acid are dissolved into about 4 L methylene chloride. The solution is transferred into a 12L reaction flask assembled for reflux with the following; cold water condenser, overhead mechanical stirrer, temperature regulator, thermocouple, nitrogen inlet adapter, addition funnel, and other misc. glassware adapters. 920 grams oxalyl chloride are then carefully weighed out, diluted with 600 milliliters methylene chloride and transferred into an addition funnel positioned over the reaction flask. A slight, constant nitrogen flow is swept through the reactor headspace to exclude oxygen. The oxalyl chloride is then slowly added to the reaction flask with stirring at room temperature. It is important to add the oxalyl chloride very slowly to control the evolution of gas that is formed as the fatty acid is converted to fatty acid chloride. Upon complete addition of the oxalyl chloride, the reaction is allowed to continue at room temperature until all of the fatty acid carbonyl is converted to fatty acid chloride as monitored by FTIR. The DCO fatty acid chloride is the evaporated using a rotary evaporator.

500 grams of DCO fatty acid chloride are weighed out and diluted with about 500 milliliters methylene chloride. 45 grams sucrose are transferred into a 5 L reaction flask (assembled for reflux) along with 300 milliliters N,N-dimethylformamide and 600 milliliters pyridine. The sucrose solution is stirred at 60° C. until dissolved and then cooled to approximately 30° C.; a very slight but constant nitrogen flow is swept through the reactor headspace. The DCO fatty acid chloride solution is then transferred into an addition funnel positioned over the reaction flask and slowly added to the stirring sucrose solution. The reaction is allowed to continue at approximately 40° C. until the hydroxyl peak disappeared when analyzed by FTIR. The solution is then water washed several times, the organic layer separated and then dried over anhydrous magnesium sulfate. The solutions are then filtered to remove the MgSO₄ and evaporated to dryness using a rotary evaporator. The crude DCO sucrose polyester is then extracted 3 times with hot methanol to remove any residual fatty acid or fatty acid chloride that remains. The DCO sucrose polyester is then heated to about 100° C. under full vacuum (<2 mm Hg) to remove trace solvent, transferred into clean jars, blanketed with nitrogen and stored at 40° F.

Paints and Resins

Alkyd Resins

The following alkyd resins were prepared.

| | | |
|---|---|---|
| 10A | control | soya long oil alkyd 70% solids CHEMPOL ® 801-2426 |
| 10B | 60/40 | 8012426/Sucrose Polyester - Soybean Oil Esters |
| 10C | 60/40 | 8012426/Sucrose Polyester - 50% Soybean Oil/50% |
| | | Dehydrated Castor Oil Esters |
| 10D | 60/40 | 8012426/Sucrose Polyester - Tung Oil Esters |
| 10E | 60/40 | 8012426/Sucrose Polyester - Dehydrated Castor Oil |
| | | Esters |

Resins 9B-9E are 85% solids in mineral spirits.

Clear Resin Examples

| | | 10B-E (Each made with |
|---|---|---|
| PBW | 10A | corresponding alkyd resin |
| Alkyd resin | 128.6 | 105.9 |
| Mineral spirits | — | 22.7 |
| 12% cobalt drier | 0.5 | 0.5 |
| 5% calcium drier | 1.8 | 1.8 |
| 12% zirconium drier | 1.5 | 1.5 |
| Anti-skin | 0.2 | 0.2 |
| Activ-8 | 0.6 | 0.6 |

White Paint Examples

| PBW | 11A | 11B-D | |
|---|---|---|---|
| Alkyd resin | 128.6 | 100.0 | |
| Mineral spirits | 50.0 | 55.0 | |
| Organoclay thixotrope | 5.0 | 5.0 | Crayvallac OC-150 |
| Byk P104 | 4.0 | 4.0 | pigment dispersant |
| Titanium dioxide | 400.0 | 400.0 | TiPure ® R902 |
| Lampblack | 0.1 | 0.1 | Elementis LB1011 |

High speed Cowles disperse 15 minutes, and let down with

| | | |
|---|---|---|
| Alkyd resin | 200.0 | 200.0 |
| Mineral spirit | 20.0 | 20.0 |

Take above reduced grind paste and let down further into

| | | |
|---|---|---|
| Alkyd resin | 300.0 | 200.0 |

Continue let down

| | | | |
|---|---|---|---|
| Alkyd resin, adjusting | 50.4 | 59.2 | |
| 12% cobalt drier | 2.8 | 2.8 | |
| 5% calcium drier | 9.5 | 9.5 | |
| 12% zirconium drier | 8.0 | 8.0 | |
| Anti-skin | 2.1 | 2.1 | |
| Activ-8 | 3.0 | 3.0 | |
| Mineral spirits | 73.6 | 33.7 | viscosity adjust |
| % solids | 71.1 | 81.2 | |

Data Comparison

TABLE 1

| | | Hard | | MEK |
|---|---|---|---|---|
| | | Dry | | # Dry |
| Long Oil Alkyd w/White Pigment | VOC | Time | | Rub's |
| Solvent Based Control | 380 | 6 | hrs | 100 |
| (No polyol polyester) | | | | |
| Soy Sucrose Polyester | 240 | >9 | hrs | 265 |
| (100% Soybean Oil Esters) | | | | |
| Tung Sucrose Polyester | 250 | Fail- | | |
| (100% Tung oil, ~80% eleostearic acid) | | wrinkle | | |
| DCO Sucrose Polyester | 250 | 4½ | hrs | 230 |
| (100% Dehydrated castor oil; | | | | |
| ~40% conjugated linoleic acid) | | | | |
| Sucrose Polyester | 250 | 5½ | hrs | 250 |
| (50% Soybean +50% dehydrated castor oil; | | | | |
| ~20% conjugated linoleic acid | | | | |

White pigmented long oil alkyd coating compositions were prepared. As can be seen in Table 1, all sucrose polyesters allow for the reduction of the VOC content in the coatings by approximately 33% and provide a MEK solvent resistance improvement over standard solvents. It can be seen that drying control of the sucrose polyester is achieved to match that of the traditional solvents by the use of dehydrated castor oil esters on the polyol polyesters.

TABLE 2

| | Hard | |
|---|---|---|
| | Dry | |
| Long Oil Alkyd - Clear w/ 74% solids | Time | |
| Solvent Based Control | 6½ | hrs |
| (No polyol polyester) | | |
| Soy Sucrose Polyester | >9 | hrs |
| (100% Soybean Oil Esters) | | |
| Tung Sucrose Polyester | Fail | |
| (100% Tung oil, ~80% eleostearic acid) | wrinkle | |
| DCO Sucrose Polyester | 5 | hrs |
| (100% Dehydrated castor oil; ~40% conjugated linoleic acid) | | |
| Sucrose Polyester | 6 | hrs |
| (50% Soybean +50% dehydrated castor oil; ~20% conjugated | | |
| linoleic acid | | |

Long oil alkyd clear resins were made, each comprising 74% solids content. The resins were again made with sucrose polyesters. Again, as can be seen in Table 2, drying control of the sucrose polyester is achieved by the use of dehydrated castor oil esters on the polyol polyesters

As used herein, the term “comprising” means various components conjointly employed in the preparation of the compositions of the present disclosure. Accordingly, the terms “consisting essentially of” and “consisting of” are embodied in the term “comprising”.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising a highly esterified polyol polyester wherein the polyester comprises a polyol residue and a plurality of fatty acids esters, and wherein from about 5% to about 80% of the fatty acid esters contains exactly one pair of conjugated double bonds.

2. The composition recited in claim 1 wherein the polyol residue is a residue of a polyol selected from the group consisting of sugars, sugar alcohols, and mixtures thereof.

3. The composition recited in claim 2 wherein the polyol residue is a residue of a polyol selected from the group consisting of adonitol, arabitol, sorbitol, mannitol, galactitol, isomalt, lactitol, xylotol, maltitol, 1-methyl-glucopyranoside, 1-methyl-galactopyranoside, 1-methyl-mannopyranoside, dextrin, erythritol, pentaerythritol, diglycerol, polyglycerol, sucrose, amylose, nystose, kestose, trehalose, raffinose, gentianose, and mixtures thereof.

4. The composition recited in claim 1 wherein the highly esterified polyol polyester has an average esterification of from about 70% to about 100% with one or more fatty acids selected from those contained in the group consisting of anteisoarachadic, behenic, bosseopentaenoic acid, calendic, capric, caprylic, catalpic, eicosadienoic, eleostearic, erydiogenic, isomargaric, isomyristic, isostearic, jacaric, lauric, lesquerolic, licanic, linoleic, linolenic, myristic, oleic, palmitic, parinaric, punicic, ricinoleic, rumenic, ricinenic, stearic acids and mixtures thereof.

5. The composition recited in claim 1 wherein the fatty acids are selected from the group consisting of stearic acid, oleic acid, linoleic acid, linolenic acid, eleostearic acid, ricinoleic acid, rumenic acid, and mixtures thereof.

6. The composition recited in claim 1 wherein the fatty acids comprise from about 8% to about 24% of a conjugated linoleic acid.

7. A polyol polyester composition comprising two or more different highly esterified polyol polyesters wherein each polyol polyester comprises a polyol residue and a plurality of fatty acid esters, and wherein from about 5% to about 80% of the total ester fatty acids in the composition contain exactly one pair of conjugated double bonds.

8. The composition recited in claim 7 wherein the polyol residue is a residue of a polyol selected from the group consisting of sugars, sugar alcohols, and combinations thereof.

9. The composition recited in claim 8 wherein each polyol polyester has an average esterification of from about 70% to 100% with one or more fatty acids selected from those contained in the group consisting of anteisoarachadic, behenic, bosseopentaenoic acid, calendic, capric, caprylic, catalpic, eicosadienoic, eleostearic, erydiogenic, isomargaric, isomyristic, jacaric, lauric, lesquerolic, licanic, linoleic, linolenic, myristic, oleic, palmitic, parinaric, punicic, ricinoleic, rumenic, rumelenic, ricinenic, and stearic acids.

10. The composition recited in claim 9 wherein the fatty acids are selected from the group consisting of stearic acid, oleic acid, linoleic acid, linolenic acid, eleostearic acid, ricinoleic acid, and rumenic acid.

11. The composition recited in claim 10 wherein the fatty acids comprise from about 8% to about 24% of a conjugated linoleic acid.

12. A composition comprising a highly esterified polyol polyester wherein the polyester was esterified by the reaction with one or more fatty acid methyl esters derived from a material selected from the group consisting of soybean oil, safflower oil, canola oil, castor oil, dehydrated castor oil, corn oil, linseed oil, flaxseed oil, coconut oil, cottonseed oil, olive oil, tall oil, palm oil, tung oil, and combinations thereof in an amount sufficient to have from about 5% to about 80% of the fatty acid esters in the polyol polyester containing exactly one pair of conjugated double bonds.

13. The composition recited in claim 12 wherein each polyol has an average esterification of from about 70% to 100% formed by a process of esterifying the polyol with a blend fatty acid methyl ester derived from dehydrated castor oil and soy bean oil.

14. The composition recited in claim 12 wherein the polyol polyester is a sucrose polyester having an average esterification of from about 70% to about 100% formed by a process of esterifying sucrose with a blend of fatty acid methyl esters derived from an oil comprising from about 20% to about 100% dehydrated castor oil and from about 0.1% to about 80% soybean oil.

15. The composition recited in claim 12 wherein the oils comprise from about 40% to about 60% dehydrated castor oil and from about 40% to about 60% soybean oil.

16. The composition recited in claim 12, wherein the oils comprise about 50% dehydrated castor oil and about 50% soybean oil.

17. A method of making a highly esterified polyol polyester comprising a polyol residue and a plurality of fatty acid esters having conjugated double bonds, comprising the steps of
a) esterifying a polyol residue with a fatty acid methyl ester containing one pair of nonconjugated double bonds to form a highly esterified polyol polyester; and
b) contacting said highly esterified polyol polyester from step (a) with a catalyst capable of conjugating said pair of double bonds to form a highly esterified polyol polyester having one or more conjugated double bonds.
